(19) United States
(12) Patent Application Publication
(10) Pub. No.: US 2016/0027094 A1
(43) Pub. Date: Jan. 28, 2016

(54) AUTOMATED ORDER HANDLING AND DELIVERY SYSTEM

(71) Applicant: ATCHAYAM BUSINESS SOLUTIONS PVT. LTD., Chennai (IN)

(72) Inventor: Satishkumar Chamyvelumani, Chennai (IN)

(21) Appl. No.: 14/775,048

(22) PCT Filed: Mar. 12, 2014
(86) PCT No.: PCT/IB2014/000301

§ 371 Date: Sep. 11, 2015

(30) Foreign Application Priority Data
Mar. 12, 2013 (IN) 1041/CHE/2013

(51) Int. Cl. G06Q 30/06; G06Q 50/12; F25D 25/04; G06Q 10/08

(52) U.S. Cl. CPC G06Q 30/0635; G06Q 10/083; G06Q 50/12; G06Q 10/087; F25D 25/04

(57) ABSTRACT

The present subject matter relates to a dispenser (102, 202, 302) for storing, preserving, and delivering a plurality of food items. The dispenser (102, 202, 302) includes a loading bay (104, 306) for placing the plurality of food items in the dispenser (102, 202, 302); a plurality of chambers (304) for storing each of the plurality of food items; an automated scanning unit (106, 308) for scanning the plurality of food items placed in the plurality of chambers (304); an automated dispensing unit (108, 310) for dispensing an identified food item from the plurality of chambers (304); and a controller (112) for controlling climate conditions within the dispenser (102, 202, 302); actuating the scanning unit (106, 308); identifying a food item, and operating the dispensing unit (108, 310) to dispense the identified food items.

### TECHNICAL FIELD

The present subject matter relates, in general, to the field of automated delivery and, in particular, to a system for automated delivery of food items.

### BACKGROUND

Catering and restauranteering are highly demanding fields of operation, where on-demand preparation of hygienic and fresh food items and their timely and reliable delivery are important factors to delight customers. In current times, customers are provided with a variety of cuisines to choose from, and dine-in facilities to treat themselves and their loved ones. As the demand for restaurants and catering facilities increase, high degrees of quality, efficiency, hygiene, and cost effectiveness should be maintained and possibly increased. Fast food or quick service restaurants strive to effectively meet variable customer demand, while at the same time provide hygienic, quality, consistent, and cost effective food and beverage items.

### SUMMARY

This summary is provided to introduce concepts related to order handling and delivery, and the concepts are further described below in the detailed description. This summary is neither intended to identify essential features of the claimed subject matter nor is it intended for use in determining or limiting the scope of the claimed subject matter.

In one implementation, the present subject matter relates to a dispenser for storing, preserving, and delivering a plurality of food items. The dispenser may include a) a loading bay for placing the food items in the dispenser; b) a plurality of chambers for storing and dispensing each of the food items; c) an automated scanning unit for scanning the food items placed in the chambers to generate a scan map indicative of locations and time tag of preparation of each of the plurality of food items; d) an automated dispensing unit for dispensing an identified food item from the chambers; and e) a controller for controlling climate conditions within the dispenser for preservation of the food items, for actuating the scanning unit based on at least one of an order parameter and a completion of the placing the food items in the dispenser, identifying a food item based on the scan map, and for operating the dispensing unit to dispense the identified food items.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 shows a schematic diagram of a system for handling orders and deliveries, in accordance with an embodiment of the present subject matter.

FIG. 1(a) shows a delivery control unit, in accordance with an embodiment of the present subject matter.

FIG. 2 shows a schematic implementation of a system for managing orders and deliveries at a restaurant, in accordance with an embodiment of the present subject matter.

FIG. 3 shows a dispenser for storing, preserving, and delivering food items, in accordance with an embodiment of the present subject matter.

### DETAILED DESCRIPTION

Multiple factors are responsible for the success or failure of a restaurant. Factors, such as location, pricing, and taste, may play pivotal, if not critical, roles in establishing the name and reputation of the restaurant over a period of time. Nowadays, self service and takeout restaurants provide extensive menus with a plurality of cuisines and dishes, from which the customer may select one or more items. Customers generally queue up at a counter behind which a staff member is posted to take and to serve an order given by the customer. The customer selects food items from the menu and conveys to the staff member his selection, which can include various food items including beverage items. The staff member then passes on this selection information in the form of a customer order to the kitchen, where kitchen staff organize and prepare the ordered items keeping in mind various guidelines and instructions as stipulated by the management. These guidelines may include hygiene and food handling instructions, safety and hazard guidelines, dish preparation times, and presentation. Once the order is prepared, the staff member, upon being informed of such readiness of the ordered items, picks up the items and proceeds to deliver the dishes to the customer, while all the while maintaining hospitable conduct and courtesy.

As is deduced from the above description, in order to provide good quality food and service to hundreds and possibly thousands of customers every day, the restaurant is highly dependent on its staff. In other words, self service and takeout restaurants are usually labor intensive, and factors, such as human fatigue, may affect the alertness, courtesy extended to the customer, reliability, and consistency of the service. The extent of fatigue may depend on whether the restaurant is overstaffed or understaffed, and can thus be accelerated during periods of high occupancy in these restaurants. Customers may have to wait for substantially long periods of time to be served at the counter due to the vast number of customers being served, during which time the customer may get frustrated or displeased. Depending on how alert the staff member is, he may incorrectly note down the order or omit certain dishes or details, which could result in higher levels of dissatisfaction for the customer. Safety and hazard levels in the kitchen are also elevated during peak hours when the kitchen staff is always in a hurry to attend to every order that is received. Furthermore, under such conditions, chefs may not be able to give as much time and attention to every dish, thereby resulting in a probable loss of efficiency and consistency towards the final product. Prepared dishes waiting to be served at the table may become cold, and thus may have to be re-heated before being served to the customer, thereby resulting in further delays.

Furthermore, individuals or members of a family may wish to dine at different popular restaurants; however, due to limitations of distance of these different popular restaurants, it may not be always possible to visit these popular restaurants to enjoy the cuisine thereof. Multi-restaurant facilities, such as food courts at malls and popular shopping areas, provide various popular restaurants located in one area. However, these food courts generally suffer from similar disadvantages as other manually managed restaurants as described above, thereby leading to long queues, overburdened staff, and long preparation times.

Therefore, labor intensive restaurants are in a delicate balance where pivotal roles are played by the staff. In case the above described operations are not handled professionally and efficiently, customers usually end up dissatisfied, thereby affecting the name and reputation of the restaurant. Moreover, safety and health concerns among staff and customers are also important and integral to the successful operation of a restaurant.

The present subject matter relates to an automated system for handling orders and deliveries of food and beverage items. The order handling and delivery system can be implemented at various kinds of restaurants or catering facilitates, such as quick service restaurants, so called fast food restaurants, self service restaurants, takeout restaurants, or home delivery restaurants. The order handling and delivery system also covers sourcing of food items from multiple kitchens that are not co-located with the order handling and delivery system. These kitchens include a common kitchen serving multiple order handling and delivery systems and also kitchens of popular restaurants.

In one implementation, the automated order handling and delivery system includes means for ordering food items including beverage items, hereinafter simply referred to as food items. The means for ordering the food items can include one or more ordering kiosks, coupled to a computing system, for customers to select food and beverage items of choice and make their orders. Hereinafter, reference to food items includes reference to beverage items or combinations thereof.

In one implementation, the ordering kiosk may be communicatively coupled to a computing system. The ordering kiosk is provided with a display and input means for using as an interface to the customers to provide their selection of one or more food items based on their preferences. In one implementation, a display may be provided with a touch screen. Various food items including beverage items, and food and beverage combos, can be displayed to a customer on a display, and the customer, based on his preference, can select one or more of these food items and confirm his order by pressing an accept/confirm button on the screen. In said implementation, the ordering kiosk can thus receive at least one food item selection from the customer.

In one implementation, the ordering kiosk can be provided to display information pertaining to each of the food items alongside each food item. The information, such as a description of a food item, stock status including out of stock alerts, and spice levels indicating, for example, either hot, medium, or low, can be indicated to the customer in order for him to make an informed order selection. Furthermore, the ordering kiosk can also provide options regarding the desired temperature of the delivered food item. The selection of the temperature of the food item can hereinafter be referred to as temperature preference.

In another example, certain food items may not be provided with a temperature preference. For example, food items, such as yoghurt, carbonated drinks, ice creams, fresh salads, and certain desserts, which are generally not consumed hot, are not provided with temperature options for the customer to choose.

Once the customer has made the at least one food item selection and the corresponding temperature preferences, the ordering kiosk can provide one of a plurality of payment modes for the order.

In one implementation, the ordering kiosk generates an order token based on the payment made by the customer. In one example, the order token will help the customer identify when his order is ready for pick up.

In another implementation, user devices, such as cell phones, smart phones; personal digital assistant (PDAs) including tablets, netbooks, and laptops may be communicatively coupled to the computing system and the user devices may further be provided with web based software applications, where the user can utilize the functionality of said applications to order the food items in a similar manner as is done on the ordering kiosk.

In one implementation, once the order is confirmed by the customer, the ordering kiosk or the user device transmits the food item selection to an order handling unit. The order handling unit generates order parameters based on the selection of the food items. The order handling unit then transmits the order parameters to a further process module, downstream of the ordering station.

In one implementation, the automated order handling and delivery system also includes one or more dispensers. The dispensers can be pre-loaded with the food items, including beverage items. The food items can be supplied from one or more kitchens which are not co-located with the automated order handing and delivery system and then stored in the one or more dispensers accordingly.

In one implementation, the food items can be primarily tagged with identification information, such as a barcode, and then stored in the dispenser. As disclosed above, the order parameters can include a barcode number, which is utilized to find a corresponding barcode number of a food item in the dispenser. Therefore, the tagging of the food items facilitate efficient identification and dispensing of the food items as will be described in a later portion of the draft. It is also within the scope of the present subject matter to tag each food item with Radio Frequency Identification (RFID) tags in order to effectively locate and unload the food items.

In one implementation, the dispenser has multiple chambers, in which the food items can be effectively stored for preservation and then dispensed as and when desired/required. The preservation of the food items is further enhanced by climate control means. The climate control means, for example, a Vapor Absorption Refrigeration (VAR) system, is capable of being controlled, for example, by a controller, to effectively maintain cold temperatures within the dispensers to extend the shelf life and maintain the freshness of the food items within the dispenser.

In one implementation, the dispenser may have heating elements within the lattice structure. In order to deliver heated food items, the lattices in the dispenser can be provided with hot air or steam.

In one implementation, the dispenser includes a loading bay for replenishment of the food items, where the loading bay is situated at one of a rear or lateral region, of the dispenser. The loading bay, for example, can be situated on the other side of a restaurant wall, against which the dispenser is disposed. In one example, each dispenser can correspond to a particular food chain or food category. Here, for example, based on the type of cuisine, different food items can be stored in different dispensers. In a further implementation, the food items can primarily be tagged and then be stored or shelved in the dispenser. In another example, the restaurant implementing the automated order handling and delivery system according to the present subject matter can have multiple dispensers for storing food and beverage items from a plurality of different restaurants. In said example, food items from one or more or kitchens, including kitchens of various popular restaurants can be effectively stored in one dispenser according to the present subject matter. Examples of popular restaurants include, but are not limited to, Namma Veedu Vasantha Bhavan™, Punjabi Nation, Aasife and Brothers Biryani, and Karaikudi Chettinaad Restaurant. These popular restaurants may be popular in a particular neighborhood, or on a larger scale, such as on a national or global scale. Similarly, food items from one kitchen can be stored in more than one dispenser. In this manner, customers can avail the benefit of multiple cuisine options and restaurant foods under one roof in a consistent and time-efficient manner.

In one implementation, the dispenser includes a scanning unit, which is provided to scan the stored food items during or immediately after the replenishment or loading thereof. In another implementation, the scanning unit can scan the food items later during a dispensing operation when the customer makes a selection for one or more food items. Based on the scanning, a scan map is generated which provides details of a food item, its time tag of preparation, and the like, stored in each of chambers in the dispenser. In one example, the scanning unit can include a servo motor arm coupled with a barcode reader. In one implementation, the scanning unit is controlled by a controller; in one example the controller may be implemented as a Programmable Logic Controller (PLC). In said example, the controller receives the at least one generated order parameter from a delivery control unit, which can be located in the scan map. Upon receiving the at least one order parameter, the controller identifies the location of the ordered or required food item based on the time tag and the temperature preference of the customer.

In a further example, the controller operates on a First In First Out (FIFO) methodology, by which the earliest tagged food item can be identified and dispensed from the dispenser. In this manner, there is minimum wastage of goods, and the food items can be efficiently stored and categorically dispensed in an automated manner.

In one implementation, the dispenser includes an automated dispensing unit for dispensing of the identified food item from the storage chambers. In one example, the dispensing unit includes an electromechanical arm, which can be driven by a drive unit. The drive unit can include various types of drives, such as servo motors and electric or pneumatic actuators. The drive unit can further be mated with a suitable transmission, such as a splined shaft, or a ball screw. Furthermore, in one implementation, the controller can operate the dispensing unit to unload the identified food items. Therefore, the dispensing unit provides a high degree of automation to the automated order handling and delivery system of the present subject matter, whereby quick service restaurants and takeout restaurants can increase their productivity and provide customers with hygienic and consistent food and beverage items.

In one implementation, the dispensing unit can be operated by the controller in such a manner, so as to retrieve the food item of choice and unload said food item onto a conveyor belt of a delivery apparatus. In one example, the dispensing unit can be set up to automatically pierce the lid or film of a container being dispensed prior to heating to facilitate proper escape of steam and to avoid pressure build-up within the container.

In one example, the controller keeps stock of the food items stored in the one or more dispensers by monitoring the loaded food items and the unloaded food items. Once a food item is selected by the customer at the ordering kiosk, the controller can be set up to tally the food item in an electronic inventory. In this manner, when a particular food item is depleted from the dispenser or is nearing depletion, a replenishment order can be either automatically or manually forwarded to the restaurant from where the food item originates for re-stocking.

In one implementation, the delivery apparatus, by means of the conveyor belt, effectively delivers the at least one food item to a delivery station from where the customer can pick up his order. In an implementation, the delivery apparatus is set up to convey the at least one food item selectively to a heating apparatus for heating the food item, based on the order parameter as disclosed earlier. For example, an industrial microwave oven may be disposed subsequently downstream of the dispenser on one path of the delivery apparatus, and based on the temperature preference included in the order parameter, the food item can be heated to a desired level in the heating apparatus.

Furthermore, in one implementation of the present subject matter, one or more delivery stations can be situated downstream of the delivery apparatus. The delivery stations can be points of pick up for the prepared food items or completed orders. In one example, upon completion of the heating operation, the delivery system can deliver the at least one heated food item to at least one of the delivery stations, whereupon the customer can be notified to pick up the delivered food item. In the event that the customer wishes to obtain a cold product and inputs the temperature preference as such, the delivery apparatus can bypass the heating apparatus and deliver the food item directly to the delivery station.

In one implementation, the system includes at least one display apparatus, which displays an alert notification to the customers upon successful delivery of the food item. In one example, the notification can be displayed to the customer by a display screen in the restaurant, and the notification can consist of the order number, which was supplied to the customer after the payment for the order. In this manner, the customer can verify his or her order token, provided at the time of payment, with the number being displayed on the display apparatus.

In the odd circumstance that the customer is unavailable at the instant the notification is being displayed on the display apparatus, a member of staff present in the restaurant can be notified, for example, by an alert system configured on a user device, or by a staff computing system provided to oversee the operations at the restaurant. In one implementation, if the delivered food item is not picked up within a predefined time period, say, within 1 minute, the delivery apparatus can notify. The staff can then proceed to remove the delivered food item to make way for subsequent orders to make it through to the delivery station.

In this manner, the system according to the present subject matter can substantially enhance operations at traditional quick service restaurants, self service restaurants, and takeout restaurants. Various disadvantageous and hindrances that may otherwise occur due to overstaffing and understaffing, such as human error, fatigue, hygiene, and safety related issues, can be overcome by the substantially high degree of automation conferred by the system according to the present subject matter. Furthermore, due the reduced manpower, apart from the various benefits conferred as disclosed above, running costs of these establishments can also be substantially reduced. Moreover, customers can avail the comfort of having cuisine and foods from various restaurants being served under one roof, thereby increasing the convenience factor of eating out.

Furthermore, by the implementation of the system according to the present subject matter, the need for an on-site kitchen is omitted. In other words, apart from the storage of basic cutlery and serving utensils, the requirement for any cooking material and infrastructure, such as cooking ingredients, electric or gas stoves, cooking counters, cooking utensils, exhaust systems, cleaning staff, cooks, and helpers are omitted. This substantially reduces the running costs of the establishment, thereby maximizing productivity and output, while increasing cost effectiveness and hygiene and safety standards.

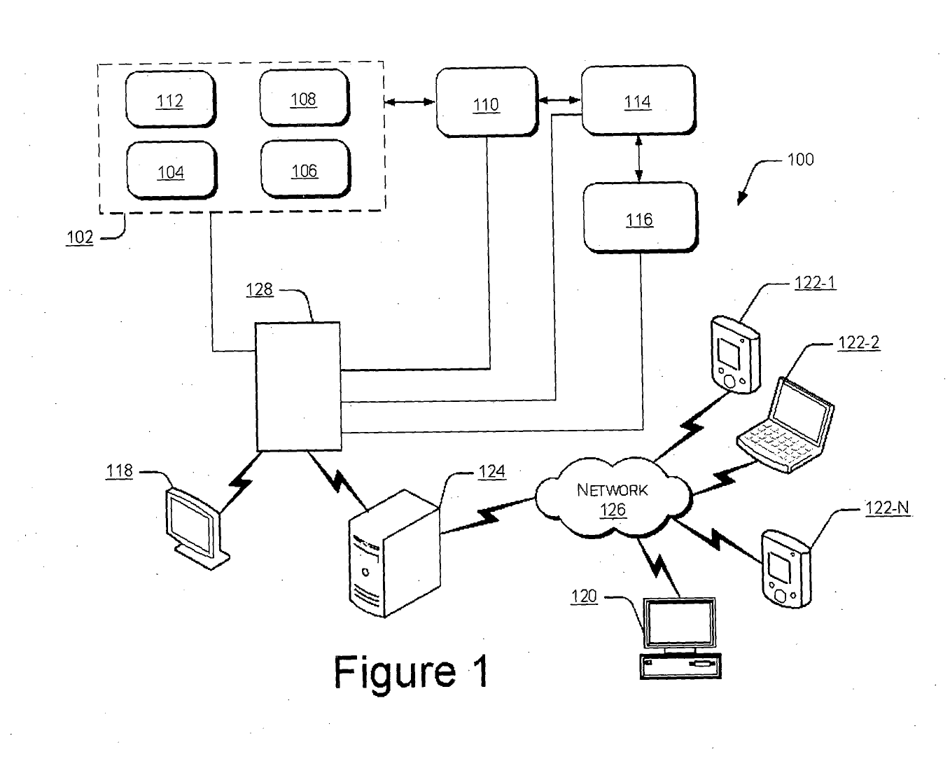

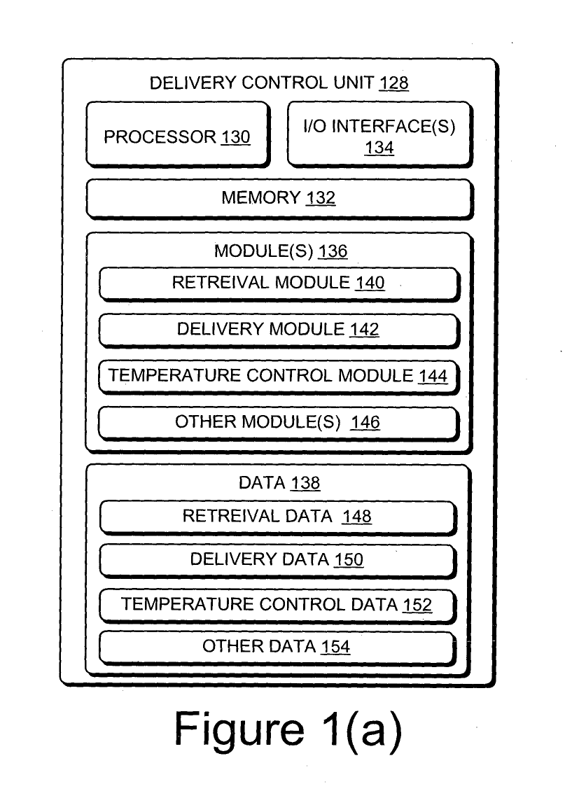

FIG. 1 shows a schematic diagram of an order handling and delivery system 100, hereinafter referred to simply as system 100, in accordance with an embodiment of the present subject matter. In one implementation, the system 100 includes multiple functional components that are schematically illustrated in the figure.

According to the present subject matter, the system 100 includes a dispenser 102 having a loading bay 104 for placing food items in the dispenser having a plurality of chambers in which multiple food items can be stored.

In one implementation, the food items can be tagged before they are placed in the dispenser 102. The tagging allows for efficient order handling and delivery later on in the process.

In an implementation, the dispenser 102 includes a scanning unit 106. The scanning unit 106 can be provided to scan the stored food items for identifying a food item based on an order parameter. The dispenser 102 also includes an automated dispensing unit 108 to retrieve and unload the identified food item from the dispenser 102.

In one implementation, the dispenser 102 includes a controller 112. The controller 112 can be implemented as any microcontroller, such as a Programmable Logic Controller (PLC). The controller 112 is provided for controlling the climate control means as provided earlier within the dispenser 102 for preservation of the food items, for actuating the scanning unit 106 based on the order parameter, and for operating the dispensing unit 108 to unload the identified food items.

In one implementation, the controller 112 actuates the scanning unit 106 for scanning the food items in the dispenser 102. For example, when preloading the dispenser 102 with food items, the tagging information can also include a timestamp of loading. After completing the preloading of the food items in the dispenser, for example, upon closing the loading bay 104, the scanning unit 106 sequentially scans the stored food items, for example, based on a jog-trigger methodology, and subsequently generates a scan map indicative of locations and time tags of preparation of each of the multiple food items. In one example, the scan map can be output to a computing system. From the scan map, at the time of dispensing a food item, the earliest tagged food item can be identified for dispensing by the controller 112 based on the timestamp. This can be referred to as the First In First Out (FIFO) methodology. In this manner, food wastage due to expiry of food items can be reduced, if not avoided completely

Furthermore, the controller 112 can tally stocks in the dispenser 102 by monitoring the loaded food items and the unloaded food items. In one example, when the dispensing unit 108 unloads an identified food item from the dispenser 102, the controller 112 notes the unloaded food item in an electronic inventory. In this manner, the restaurant can maintain logs of depleted stocks in the dispensers and issue a replenishment order to supply restaurants or food chains to supply the depleted food items. The replenishment operation can occur independently of the restaurant operation, thereby not interfering with daily business or running of the restaurant. In one example, the replenishment order can be provided by the controller 112 when multiple food items are depleted from the dispenser 102. In this manner, the restaurant can keep a tab on the inventory in the dispenser 102 and issue timely replenishment orders to one or more supply sources, such as restaurants or food chains. In a further example, the supply restaurants, i.e., the restaurants or caterers that supply the restaurant with food items can be contacted through a communication network and be automatically notified of stock status by the controller 112. Orders can be released through the communication network either automatically or manually in a periodic manner, thereby ensuring freshness of stocked foods in the dispenser 102.

In one implementation, a delivery apparatus 110, for example, the conveyor belt, can deliver the at least one food item, selectively through a heating apparatus 114 to a delivery station 116. For example, if the order parameter includes a temperature preference to heat the food item, the delivery apparatus 110 conveys the at least one food item through the heating apparatus 114 in order to heat the food item accordingly. Furthermore, in case the order parameter includes a temperature preference to not heat the food item, i.e., for a cold food item, the heating apparatus 114 can be bypassed suitably. In one example, the heating apparatus 114 can be turned off to directly deliver the food item to the delivery station 116. For example, upon selecting ‘date pancakes’ from the menu, the customer may be provided with additional options on the display interface as to whether he would like the pancakes hot, at room temperature, at stored temperature, or any other preferred temperature. In one example, in case the customer is interested in eating the pancakes at the restaurant, he may select the hot option. However, if he wishes to simply carry it home and eat it there, he may select the cold option.

Once the food item is delivered to the delivery station 116, at least one display apparatus 118 can be triggered to display a notification to customers on a display screen, wherein the notification includes the order number generated at the time of payment. In one implementation, the customer can be required to provide proof of order purchase in order to collect the delivery, for example, by producing a valid order token.

In one implementation, the system 100 includes one or more ordering points. The ordering points can be various points or locations where customers can browse the various food and beverage items available at the restaurant and provide their order selections. In the implementation shown in FIG. 1, the various order points are shown as ordering kiosks 120, and user devices 122. In an implementation, there can be multiple user devices 122-1 . . . 122-N, hereinafter collectively referred to simply as user devices 122 and individually referred as user device 122. The ordering kiosk 120 can include a computing system, such as a desktop computer, or a touch screen computing system, such as a tablet computer. The ordering kiosk 120 may be either placed in the restaurant or at any convenient point away from the restaurant for ease in ordering. Further the user devices 122 may be used while the user is seated in the restaurant or at locations away from the restaurant. Thus the ordering kiosk 120 or user devices 122 provide ease in ordering from any location. In one implementation, the order can be for home delivery or, to a desired location away from the restaurant.

In one implementation, the ordering kiosk 120 can display a menu consisting of various food and beverage items to the customer. The food and beverage items can hereinafter be referred to simply as food items. The ordering kiosk 120 can be provided with a display interface, where customers can view information pertaining to each food item so that the customer can make a more informed choice about what he would prefer to consume. Various descriptions, such as stock status including out of stock alerts, and spice levels indicating, for example, either hot, medium, or low, can be portrayed to the customer.

Furthermore, upon selecting a particular food item, the ordering kiosk 120 can provide the customer with a temperature preference option. For example, upon selecting ‘waffles’ from the menu, the customer can then be provided with an option to select a ‘hot’ or ‘cold’ temperature for his selected food item. In this manner, the ordering kiosk 120 provides various customizable options for selecting the food items.

In a further example, as shown in FIG. 1, the customer may utilize the user device 122 to select the food items. For example, the customer can utilize a smartphone 122-1 provided with a software application from which the customer can place his order. Examples of the user devices 122 include, but are not limited to personal computers, desktop computers, smart phones, PDAs including tablets, and laptops.

The user devices 122, such as the smartphone 122-1, and a laptop 122-2, can be communicatively coupled with an order handling unit 124 using a network 126. Communication links between the user devices 122 and the order handling unit 124 are enabled through a desired form of connections, for example, through dial-up modem connections, cable links, digital subscriber lines (DSL), wireless or satellite links, or any other suitable form of communication.

Moreover, the network 126 may be a wireless network, a wired network, or a combination thereof. The network 126 can also be an individual network or a collection of many such individual, networks interconnected with each other and functioning as a single large network, e.g., the internet or an intranet. The network 126 can be implemented as one of the different types of networks, such as intranet, local area network (LAN), wide area network (WAN), the internet, and such. The network 106 may either be a dedicated network or a shared network, which represents an association of the different types of networks that use a variety of protocols, for example, Hypertext Transfer Protocol (HTTP), Transmission Control Protocol/Internet Protocol (TCP/IP), etc., to communicate with each other.

By ordering from the user devices 122, for example, from the comfort of ones home, long queues may be avoided at the restaurant, and the user can efficiently order and pick up his food items from the restaurant or opt to have it delivered to his home.

Furthermore, after making a selection of one or more food items, the ordering kiosk 120 can query the customer for confirmation of the order. Moreover, the ordering kiosk 120 can provide an option to specify a pick up time for the order. In this manner, complications regarding remotely received orders, for example, from the user device 122, can be avoided. Upon confirmation, the customer can be provided with one or more payment options. The payment modes/instruments can include, but is not limited to, credit card, debit card, cash, net banking, and coupons. In one implementation, the payment transactions can be facilitated either through the ordering kiosk 120 (electronic means), or by a physical interface, for example, a cashier.

Once the payment transaction is completed, the ordering kiosk 120 can generate an order token. If the order is placed through the user device 122, the order handling unit 124 can deliver an order receipt by an email or Short Messaging Service (SMS). The order token, apart from serving as a statutory cash receipt with a timestamp, also contains an order number, which can help the customer recognize and pick up his order after delivery.

The order handling unit 124 receives food item selections from one or more of the above mentioned order points, and generates at least one order parameter based on the food item selections from each customer. The order parameters, for example, can relate to a food item selection, and a corresponding temperature preference. These order parameters, once generated, can either be stored locally within the ordering handling unit 124, or can be stored over a network in a remote database.

In one implementation, the order handling unit 124 can transmit the one or more order parameters to a delivery control unit 128 (explained in detail with regard to FIG. 1(a)). The delivery control unit 128, as schematically shown in FIG. 1(a), interacts with the main components of the system 100, such as the dispenser 102, the scanning unit 106, the dispensing unit 108, the delivery apparatus 110, the heating apparatus 114, and the delivery station 116. It is to be noted that each of the above mentioned system components are described with regard to a single component; however, it is within the scope of the present subject matter to incorporate more than one of each of the system components therein.

FIG. 1(a) shows a delivery control unit in accordance with an embodiment of the present subject matter.

In one implementation, the delivery control unit 128 controls an order delivery process at a quick service, fast food, or takeout restaurant.

In said implementation, the delivery control unit 128 includes one or more processor(s) 130, a memory 132 coupled to the processor(s) 130, and I/O interface(s) 134. The processor(s) 130 may be implemented as one or more microprocessors, microcomputers, microcontrollers, digital signal processors, central processing units, state machines, logic circuitries, and/or any devices that manipulate signals based on operational instructions. Among other capabilities, the processor(s) 130 are configured to fetch and execute computer-readable instructions and data stored in the memory 132.

The memory 132 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

The I/O interface(s) 134 may include a variety of software and hardware interfaces, for example, the I/O interface(s) 134 may enable the delivery control, unit 128 to communicate over the network 126, and may include one or more interface for peripheral device(s), such as a keyboard, a mouse, an external memory, a printer, etc. Further, the I/O interface(s) 134 may include ports for connecting the delivery control unit 128 with other computing devices, such as web servers and external databases. The I/O interface(s) 134 may facilitate multiple communications within a wide variety of protocols and networks, such as a network, including wired networks, e.g., LAN, cable, etc., and wireless networks, e.g., WLAN, satellite, etc. Further, the delivery control unit 128 also includes module(s) 136 and data 138.

The module(s) 136 include routines, programs, objects, components, data structures, etc., which perform particular tasks or implement particular abstract data types. The module(s) 136 further include a retrieval module 140, a delivery module 142, a temperature control module 144, and other module(s) 146. The other module(s) 146 may include programs or coded instructions that supplement applications and functions, for example, programs in the operating system of the user devices 122 and the delivery control unit 128.

The data 138 serves, amongst other things, as a repository for storing data processed, received and generated by one or more of the modules 136. The data 138 includes retrieval data 148, delivery data 150, temperature control data 152, and other data 154.

In one implementation, the delivery control unit 128 includes the retrieval module 140. The retrieval module 140 receives one or more order parameters from the order handling unit 124 of the system 100, for example, as illustrated in FIG. 1. The order parameters, as described earlier, can be a food item selection along with a corresponding temperature preference. In one example, the food item selection corresponds to a food or beverage item selection made by a customer with regard to a menu. The corresponding temperature in turn, refers to the temperature at which the customer wishes to have the selected food or beverage item. For example, the customer may select a ‘cheese sandwich’ as the food item selection, and subsequently select ‘cold’ as the temperature preference. In one implementation, the retrieval module 140 can store each order parameter in the retrieval data 148 or in an external database through the network 126. The retrieval module 140 can also receive the order number generated by the ordering kiosk 120 of the system 100, and store the order number in the delivery data 150 of the delivery control unit 128 for further reference.

In an implementation, the retrieval module 140 fetches the order parameters from the retrieval data 148 and forwards it to a dispenser. In one example, the order parameters are forwarded to the controller 112 of the dispenser 102 of the system 100 as illustrated in FIG. 1.

In one implementation, the delivery module 142 of the delivery control unit 128 can deliver the at least one food item to delivery or pick up point, such as the delivery station 116 of the system 100 as illustrated in FIG. 1. In one example, the delivery module 142 controls the delivery apparatus 110 of the system 100 as illustrated in FIG. 1, so that the delivery apparatus 110, selectively through the heating apparatus 114, conveys the food item to the delivery station 116 for the customer to obtain the food item. In one implementation, based on the temperature preference, the delivery module 142 can retain the food item within the heating apparatus 114 for a predetermined duration of time, until the food item is heated to the desired temperature. The time for which the food item is retained within the heating apparatus 114 is pre-determined for each food item and can be stored in the delivery data 150 of the delivery control unit 128.

In a further implementation, the temperature control module 144 of the delivery control unit 128 can control the heating apparatus 114 and the temperature therein. For example, based on the temperature preference, the temperature control module 144 can control the heating apparatus 114 of the system 100, by which the food item can effectively and automatically be heated to a desired temperature for delivery at the delivery station 116. For example, in case the temperature preference input by the customer is ‘cold’, i.e., the customer does not wish to heat the selected food item, the temperature control module 144 can maintain the heating apparatus 114 in the switched off mode, while the food item passes through. In one example, the temperature control module 144 can store various heating temperatures for each of the pre-loaded food items in the temperature control data 152 of the delivery control unit 128.

Once the food item is heated to the desired temperature, the temperature control module 144 can switch off the heating apparatus 114, and the delivery module 142 can proceed to deliver the food item to the delivery station 116 of the system 100. Moreover, the delivery module 142 can trigger an alert notification on at least one display apparatus 118, by which the customer can be notified to pick up his food item. In one example, the delivery module 142 can fetch the order number from the delivery data 150 and based on the order number, issue an alert notification on a display screen of the system 100. In this manner, various customers can be notified of their delivered food items and can avail of the same in a timely manner.

However, in case a customer is busy or temporarily unavailable at the time of delivery, the delivery module 142 can issue a warning notification to a member of staff, for example, through a staff computing system or a user device, which a member of staff has access to. The staff member can remove the delivered food item from the delivery station and allow other food items to progressively be delivered in the same manner.

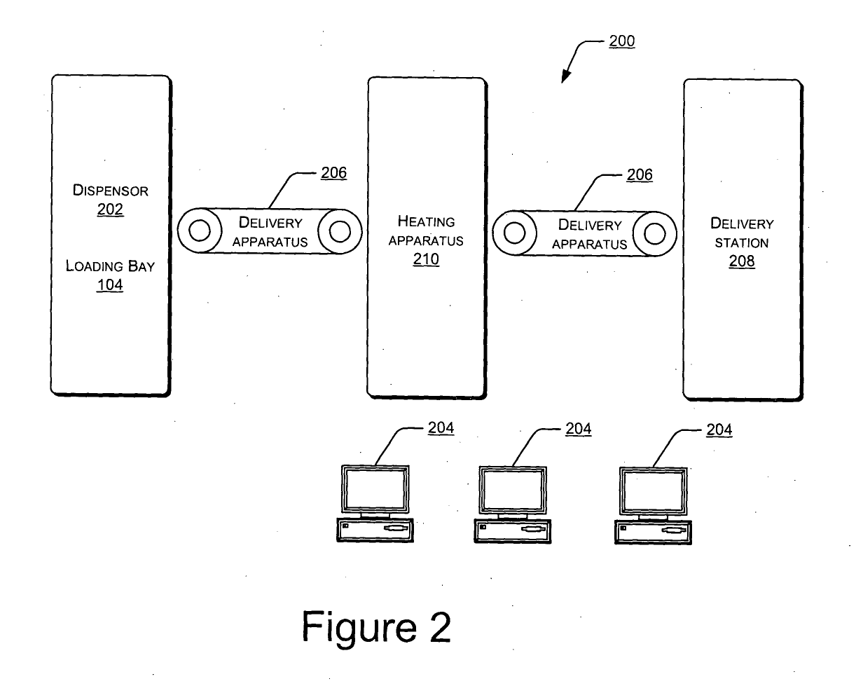

FIG. 2 shows a schematic implementation of an order handling and delivery system 200 for order handling and deliveries at a restaurant, in accordance with an embodiment of the present subject matter.

The order handling and delivery system 200 shown in FIG. 2 can be implemented at a quick service restaurant, a takeout restaurant, or a self service restaurant.

In one implementation, the order handling and delivery system 200 includes a dispenser 202 for storing, preserving, and delivering a plurality of food items. In one implementation, the dispenser 202 includes means for scanning, identifying and dispensing the food items. In an example, the dispenser 102 shown in FIG. 1 can be utilized in this implementation.

Furthermore, the order handling and delivery system 200 includes one or more ordering kiosks 204 that serve as points of ordering for customers of the restaurant. For example, customers may utilize the functionality of the ordering kiosks 204 and make a selection of one or more food and beverage items. Once the order selection is made, the customer can make a payment for the same at the ordering kiosk 204. In one example, the ordering kiosks 120 described in the embodiment of FIG. 1 can be used in the present embodiment.

In one implementation, the customers can make their orders through user devices (not shown) from a remote location. For example, the customers can utilize the functionality of software applications through which the orders can be sent to the restaurant. In a further implementation, the customer can specify, for example, through the user devices, whether he wants to eat the food item at the restaurant, or at home, in case the restaurant offers a home delivery facility.

In one implementation, the ordering kiosks 204 can transmit the selection to an order handling unit (not shown in present fig.), which further processes the selection. The order handling unit in this implementation is situated at a remote location, away from the restaurant.

The order handling and delivery system 200 further includes a delivery apparatus 206 for automatically conveying the unloaded food items to a delivery station 208, and for selectively conveying the unloaded food items through a heating apparatus 210. The delivery apparatus 206 can include a conveyor belt or an electromechanical arm in order to convey the food items. In one example, the delivery apparatus 110 shown in FIG. 1 can be utilized. In a further example, the delivery apparatus 110 can be driven by a drive means. The drive means can include various types of drives, such as servo motors and electric or pneumatic actuators. The drive means can further be operably coupled with a suitable transmission apparatus, such as a splined shaft, or a ball screw, or a planetary gear mechanism.

In one implementation, in case the customer wishes to have his food item delivered to a delivery address, such as his home, the delivery station 208 can be accessed by delivery personnel who subsequently deliver the food items to the customer present at the specified delivery address.

The heating apparatus 210 can, for example, be an automated industrial oven, through which the food items can effectively heated prior to delivery, based on a temperature preference of the customer. In one example, the heating apparatus 114 as shown in the embodiment of FIG. 1 can be utilized herein.

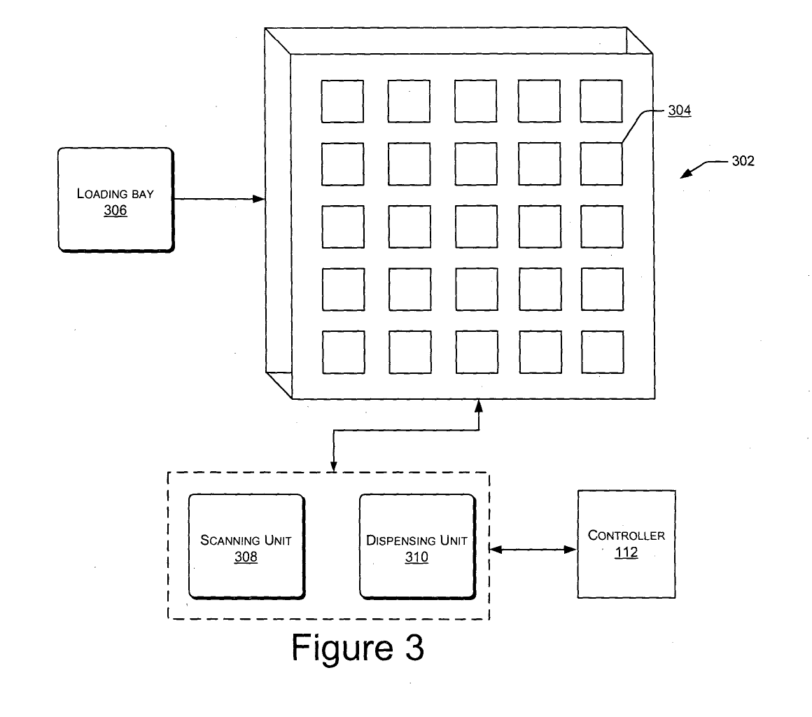

FIG. 3 shows a dispenser 302 for storing, preserving, and delivering food items in accordance with an embodiment of the present subject matter.

The dispenser 302 shown in FIG. 3 is capable of automated food storage and delivery. The dispenser 302 includes a plurality of chambers 304 in which food items can be stored and preserved. To maximize storage space within the dispenser 302, a honeycomb structure with the interconnecting lattices (for example, made of stainless steel), can be utilized to store the food items in the dispenser 302. Moreover, the preservation of the food items is enhanced by climate control means provided in the dispenser 302. The climate control means, for example a Vapor Absorption Refrigeration (VAR) system, can be controlled, for example, by a controller 112, to effectively maintain cold temperatures within the dispenser 302. In one example, the controller 112 can be a microprocessor, a microcomputer, a microcontroller, a digital signal processor, a central processing unit, a state machine, a logic circuit, and/or any device that manipulates signals based on operational instructions. In another example, the food items can be heated by hot air and/or steam provided through the interconnected lattice structure, and stored in the chambers 304. Therefore, the storage temperature can vary from hot to cold depending on the storage requirement of the food items. In a further implementation, the dispenser 302 can store the food items in a cold environment (cold storage) with the possibility of reheating dispensed food items later, and in another implementation, the dispenser 302 can store the food items in a hot environment with no requirement for subsequent reheating, or with minimal reheating.

In one implementation, the dispenser 302 includes a loading bay 306 for replenishment of the food items. For example, the loading bay 306 can be a rear opening door or loading window, through which staff can load items into the dispenser 302. Moreover, the food items are primarily tagged with identification information, such as a barcode containing a time tag of preparation, and then placed in the dispenser 302. In another example, the food items can be tagged with RFID tags, in order to effectively locate the food items when required. In one example, microwave friendly or compatible containers and trays can be used to store the food items in the dispenser 302. In one example, where the dispenser 302 is provided as a hot storage, the containers can be made of thermally conductive material, such as aluminum or tin foils, and lids of said containers can be semi sealed to allow proper escape of steam. In case the dispenser 302 is maintained at cool temperatures, the containers can be sealed by a plurality of methods, such as glue, heat, or ultrasonic sealing, to retain the moisture within. In a further implementation, the food items can be pre-packed and supplied from one or more kitchens, including kitchens of popular restaurants. The pre-packed food items can then be tagged prior to loading in the dispenser 302 through the loading bay 306. In an example, the kitchens supplying the food items are not co-located with the restaurant implementing the dispenser 302, i.e., the kitchens are at a remote location. In another example, the kitchen may be co-located at said restaurant implementing the dispenser 302.

In one implementation, the dispenser 302 includes an automated scanning unit 308. The scanning unit 308 can be provided to scan the stored food items and further generate a scan map indicative of locations and time tag of preparation of each of the food items. As described earlier, the scanning of the stored food items can occur immediately after the placing of the food items in the dispenser 302, for example, post tagging. For example, upon completion of the placing of the food items in the dispenser 302, the scanning unit 308 can be provided to scan the food items therein. In another example, the scanning unit 308 can be provided to scan the stored food items based on an order parameter, i.e., after the customer has made his order. The order parameter can be indicative of a selected one or more food items and a corresponding temperature preference of each of the selected one or more food items. In one example, the operation of the scanning unit 308 can be synonymous with the operation of the scanning unit 106 as described in FIG. 1. In one implementation, the scanning unit 308 can include a servo motor arm with a barcode reader to scan the multiple rows or shelves of stored food items. When the scanning unit 308 scans a barcode number that matches the barcode number in the order parameter, the scanning unit 308 identifies this as a match. In one implementation, as described earlier, the scanning unit 308 can be set up to scan the food items and generate a scan map based on the scanning. The scan map can be indicative of locations of each of the food items, and time tag of preparation of the food items. The scan map can then be analyzed by the controller 112, which can be provided to operate on the FIFO system, wherein the earliest stored food item matching the selection of a food item by the customer is identified as a match. For example, barcodes can also include the time tag of preparation, which is indicative of the time at which the food item was prepared and stored in the dispenser 302. In this manner, various expiry dates of the food items can be monitored, and thereby, wastage of food can be minimized. In one embodiment, the scanning unit 308 can be implemented in an automated order handling and delivery system 100 as described with regard to FIG. 1.

In one implementation, the dispenser 302 includes an automated dispensing unit 310 for dispensing the identified food item. The dispensing unit 310 can include an electromechanical arm having a drive unit. The drive unit can include a combination of servo motors, and/or electric and/or pneumatic actuators. Furthermore, the drive unit can be operably coupled with a transmission system, such as splined shafts, or ball screws, or a combination thereof. Furthermore, the dispensing unit 310 can be set up to unload the identified food item onto a delivery apparatus, for example, the delivery apparatus 110 as explained in the embodiment shown in FIG. 1. In one implementation, the dispensing unit 310 can be provided with the functionality of automatically piercing the lid of the container before it is unloaded from the dispenser 302 depending on whether the customer would like to have his food item heated. The dispensing unit 310 can be provided with a piercing apparatus (not shown) by which the dispensing unit 310 can pierce the lid of the food item to allow proper escape of steam during the heating process. In an example, the controller 112 can provide for operating the piercing apparatus based on the order parameter.

Although the subject matter has been described with reference to specific embodiments, this description is not meant to be construed in a limiting sense. Various modifications of the disclosed embodiments, as well as alternate embodiments of the subject matter, will become apparent to persons skilled in the art upon reference to the description of the subject matter. It is therefore contemplated that such modifications can be made without departing from the spirit or scope of the present subject matter as defined.

I/We claim:

1. A dispenser (102, 202, 302) for storing, preserving, and delivering a plurality of food items, the dispenser (102, 202, 302) comprising:
a loading bay (104, 306) for placing the plurality of food items in the dispenser (102, 202, 302);
a plurality of chambers (304) for storing each of the plurality of food items;
an automated scanning unit (106, 308) for scanning the plurality of food items in the plurality of chambers (304) to generate a scan map indicative of locations and time tag of preparation of each of the plurality of food items;
an automated dispensing unit (108, 310) for dispensing at least one food item from among the plurality of food items; and
a controller (112) for:
controlling climate conditions within the dispenser (102, 202, 302) for preservation of the plurality of food items;
actuating the scanning unit (106, 308) based on at least one of an order parameter and completion of the placing the plurality of food items in the dispenser (102, 202, 302);
identifying the at least one food item from the plurality of food items based on the scan map; and
operating the dispensing unit (108, 310) to dispense the identified food item.

2. The dispenser (102, 202, 302) as claimed in claim 1, wherein the plurality of chambers (304) are formed as one of a shelf structure and a honeycomb structure with integrated climate control means.

3. The dispenser (102, 202, 302) as claimed in claim 1, wherein the dispenser (102, 202, 302) further comprises climate control means, coupled to the controller (112), including one of a Variable Absorption Refrigeration (VAR) system and a hot air and steam system.

4. The dispenser (102, 202, 302) as claimed in claim 1, wherein each of the plurality of food items is tagged with a barcode including the time tag of preparation indicative of a time of preparation and storage of each of the plurality of food items for effective shelf life control of the plurality of food items.

5. The dispenser (102, 202, 302) as claimed in claim 1, wherein the scanning unit (106, 308) comprises a servo motor arm for scanning the plurality of food items stored in the dispenser (102, 202, 302), and wherein the servo motor arm is communicatively coupled with a barcode reader.

6. The dispenser (102, 202, 302) as claimed in claim 1, wherein the controller (112) actuates the scanning unit (106, 308) for identifying an earliest tagged food item for dispensing based on the scan map.

7. The dispenser (102, 202, 302) as claimed in claim 1, wherein the dispensing unit (108, 310) comprises an electromechanical arm having a piercing apparatus and a drive unit.

8. The dispenser (102, 202, 302) as claimed in claim 7, wherein the drive unit includes one of a servo motor, a pneumatic actuator, and an electric actuator.

9. The dispenser (102, 202, 302) as claimed in claim 7, wherein the drive unit is functionally coupled to at least one splined shaft, and a ball screw.

10. The dispenser (102, 202, 302) as claimed in claim 7, wherein the controller (112) operates the piercing apparatus to automatically pierce lids of each of each of the plurality of food items based on the order parameter.

11. The dispenser (102, 202, 302) as claimed in claim 1, wherein the controller (112) provides for tallying stocks in the dispenser (102, 202, 302) by keeping track of the plurality of food items stored in the dispenser (102, 202, 302) and the dispensed food items.

12. The dispenser (102, 202, 302) as claimed in claim 1 or 11, wherein the controller (112) further provides for issuing a replenishment order to at least one kitchen for supplying out of stock food items.

13. The dispenser (102, 202, 302) as claimed in claim 1, wherein the controller (112) provides an interface for receiving digital signals, and wherein the digital signals includes information related to customer order parameters.

14. A delivery control unit (128) for controlling an automated order handling and delivery system (100, 200), the delivery control unit (128) comprising:
a processor (130); and
a delivery module (142), coupled to the processor (130), to:
control a delivery apparatus (110, 206) for delivering at least one food item to a delivery station (116, 208);
selectively pass the at least one food item through a heating apparatus (114, 210) based on an order parameter related to the at least one food item; and
trigger an alert notification on at least one display apparatus (118) based on an arrival of the at least one food item at the delivery station (116, 208), wherein a customer is notified by the alert notification to pick up the at least one food item; and
a temperature control module (144) coupled to the processor (130) to actuate the heating apparatus (114, 210) based on the order parameter.

15. The delivery control unit (128) as claimed in claim 14 further comprising a retrieval module (140) coupled to the processor (130) to receive the at least one order parameter from an order handling unit (124), wherein the at least one order parameter is indicative of the at least one food item and a corresponding temperature preference of each of the at least one food items.

16. The delivery control unit (128) as claimed in claim 14, wherein the alert notification includes a token number provided on an order receipt.

17. The delivery control unit (128) as claimed in claim 14, wherein the delivery module (142) further alerts a member of staff if the delivered at least one food item is not picked up within a predetermined time period.

18. An order handling and delivery system (100, 200) for automated ordering and delivering of at least one food item comprising:
an order handling unit (124) for receiving at least one food item selection, wherein the at least one food item selection includes information relating to the at least one food item and information relating to a temperature preference of the at least one food item, and wherein the order handling unit (124) generates at least one order parameter based on the at least one food item selection;
one or more dispensers (102, 202, 302), for storing, preserving, and dispensing the at least one food item, wherein the dispenser (102, 202, 302) provides for dispensing the at least one food item;
a delivery apparatus (110, 206) for:
automatically conveying the dispensed at least one food item to a delivery station; and
selectively moving the at least one food item through a heating apparatus;
a heating apparatus (114, 210) for heating the at least one food item based on the at least one order parameter; and
a delivery station (116, 208) for receiving delivered food items.

19. The order handling and delivery system (100, 200) as claimed in claim 18, wherein the order handling unit (124) receives the at least one food item selection from one of an ordering kiosk (120, 204) and at least one user device (122), wherein the at least one user device (122) is one of a smart phone (122-1), a laptop (122-2), a netbook, a tablet, and a personal computer.

20. The order handling and delivery system (100, 200) as claimed in claim 18, wherein the order handling unit (124) is disposed at one of an on-site location and a remote location.

21. The order handling and delivery system (100, 200) as claimed in claim 18 or 19, wherein the ordering kiosk (120, 204) comprises a computing system coupled with a display interface, and wherein the ordering kiosk (120, 204):
provides a customer with a plurality of ordering options by which the customer makes the selection of the at least one food item; and
transmits the selection to the order handling unit (124).

22. The order handling and delivery system (100, 200) as claimed in claim 18, or 19, or 21, wherein the ordering kiosk (120, 204) generates an order token, containing an order number, upon payment by the customer for the at least one food item.

23. The order handling and delivery system (100, 200) as claimed in claim 18, wherein the delivery apparatus (110, 206) comprises at least one of a conveyor belt and a robotic arm.

24. The order handling and delivery system (100, 200) as claimed in claim 23, wherein the delivery apparatus (110, 206) is driven by a drive means.

25. The order handling and delivery system (100, 200) as claimed in claim 24, wherein the drive means includes one of a servo motor, a pneumatic actuator, and an electric actuator.

26. The order handling and delivery system (100, 200) as claimed in claim 24, wherein the drive unit is functionally coupled to at least one splined shaft, a ball screw, and a gear mechanism.

27. The order handling and delivery system (100, 200) as claimed in claim 18, wherein the delivery apparatus (110, 206) moves the at least one food item to the heating apparatus (114, 210) for heating the at least one food item based on the temperature preference.

28. The order handling and delivery system (100, 200) as claimed in claim 18, wherein the order handling and delivery system (100, 200) is implemented at one of a quick service restaurant, a takeout restaurant, a home delivery restaurant, and a self service restaurant.

29. The order handling and delivery system (100, 200) as claimed in claim 28, wherein one or more kitchens, including kitchens of popular restaurants are located away from the quick service restaurant, the takeout restaurant, the home delivery restaurant, and the self service restaurant.

30. The order handling and delivery system (100, 200) as claimed in claim 29, wherein the one or more kitchens supply the at least one food item to the one or more dispensers (102, 202, 302) located in the quick service restaurant, the takeout restaurant, the home delivery restaurant, and the self service restaurant,

31. The order handling and delivery system (100, 200) as claimed in claim 28, wherein a kitchen is co-located with the quick service restaurant, the takeout restaurant, home delivery restaurant, or the self service restaurant.

32. The order handling and delivery system (100, 200) as claimed in claim 18, wherein the delivery apparatus (110, 206) moves the at least one food item to a delivery personnel who subsequently deliver the at least one food item to a delivery address.
